(19) United States
(12) Patent Application Publication
(10) Pub. No.: US 2018/0330281 A1
(43) Pub. Date: Nov. 15, 2018

(54) METHOD AND SYSTEM FOR DEVELOPING PREDICTIONS FROM DISPARATE DATA SOURCES USING INTELLIGENT PROCESSING

(71) Applicants: Eric Teller, Palo Alto, CA (US); David Andre, San Francisco, CA (US); John Stivoric, Pittsburgh, PA (US)

(72) Inventors: Eric Teller, Palo Alto, CA (US); David Andre, San Francisco, CA (US); John Stivoric, Pittsburgh, PA (US)

(21) Appl. No.: 16/030,631

(22) Filed: Jul. 9, 2018

Related U.S. Application Data
(63) Continuation of application No. 12/352,911, filed on Jan. 13, 2009, now abandoned.

(51) Int. Cl. G06N 99/00

(52) U.S. Cl. CPC G06N 99/005

(57) ABSTRACT

Provided herein is a platform for prediction based on extraction of features and observations collected from a large number of disparate data sources that uses machine learning to reinforce quality of collection, prediction and action based on those predictions.

### BACKGROUND OF THE INVENTION

### Field of the Invention

The present invention is related to prediction of outcomes, and more particularly to the use of machine learning to predict outcomes.

### Description of the Related Art

Statistical analysis techniques are known, such as used by financial industry analysts, to analyze and predict outcomes based on hypothesized relationships between data and financial outcomes (such as in fundamental analysis of securities, prediction of market response to financial variables such as interest rates, and the like). However, such techniques are typically applied to limited data sets, such as trading data (e.g.k, price and volume data), data found on balance sheets and similar financial reports, or macroeconomic data published by government sources.

Artificial intelligence and machine learning techniques are known in computer science and are used to solve complex problems in a variety of fields. However, a need exists for techniques that widen the range of potentially relevant data sources for predictive analysis, such as in securities analysis, and that leverage machine learning techniques to produce more accurate predictions.

Wherever people make plans, across a wide range of business and personal domains, they must also make predictions, and a range of methods and systems have been developed to assist with those predictions. Many of those existing systems look for direct correlations of causes to outcomes; for example, if a person's blood glucose is low, one predicts that the person may have diabetes, if oil prices go up, one predicts that the S&P index will go down, and if a Democrat is elected President, one predicts that taxes will go up. Considerable effort is undertaken to improve the capacity to measure potential causes, such as to improve the sensitivity of measurement techniques or systems. For example, high cholesterol was found to predict heart disease with some reliability, but more refined measurements, separating good from bad cholesterol, improved the reliability of the predictions. Nevertheless, even with considerable effort placed on improving the quality of the input information, when one-to-one cause and effect relationships are tested in the real world, they often fail to yield good results, because most outcomes that need prediction have more than one cause. To address this factor, researchers in various fields ranging from financial analysis to physics, to biology, to econometrics, have developed multivariate statistical and analytical techniques for making predictions, typically developing mathematical models, such as linear regression models, and the like, that hold a range of potential causes as independent variables, assign coefficients to those variables, and test the models for statistical significance against real world data. These models, while potentially useful in closed or nearly closed systems (such as classical mechanics or optics in physics), rapidly become overwhelmed by two factors, complexity (in the cases of outcomes that have many causes) and uncertainty (in cases where outcomes are subject to probabilistic causes). Random walk models and the like have been made to assist in making predictions that have a moderate number of probabilistic factors (such as the fairly successful large scale computer models used to predict movements of large weather systems like hurricanes); however, where significant uncertain factors are present and where many causes potentially affect an outcome, current models for prediction often become so complex that they exceed even supercomputing capacity.

Predictors often revert to simple rules of thumb, rather than face the daunting challenges of modeling and calculation required for more complex prediction. These simple one-to-one “rules of thumb” are widely used to make predictions, often because alternative techniques, such as statistical techniques used in econometrics, rapidly become too complex as additional variables are added beyond simple one-dimensional causation.

Researchers have noted that the human brain is, in some specific cases, a very powerful calculator of certain complex predictions; for example, our sensory systems solve problems, such as predicting the motion of a ball in flight on a windy day, that would overwhelm all but the most powerful computers. These capabilities are believed to be the product of millions of years of evolution of the flexible network of billions of neurons that make up our brains, coupled with the specific reinforcement of effective neutral pathways that comes with training and experience. Successful predictions literally rewire our brains, making the neural pathways that led to them stronger while allowing ones that did not lead to successful predictions to die off (or to be repurposed for other tasks). Our visual systems, our systems for learning and using language, our systems for managing our social interactions with other people, and many other systems that require effective predictions of complex outcomes all work this way, effectively rewarding pathways that work and punishing those that do not, until the brain has become an engine for effective prediction of some type. Unfortunately, while evolution has handed each person a brain that is well adapted for the development of some kinds of predictions, (like those relating to facial recognition), the modern world has changed much more rapidly than our brains can adapt, leaving individual brains unequipped to make predictions in many domains.

A need continues to exist for methods and systems that can make predictions in situations involving many complex causes.

### SUMMARY OF THE INVENTION

Provided herein is a platform for prediction based on extraction of features and observations collected from a large number of disparate data sources that uses machine learning to reinforce quality of collection, prediction and action based on those predictions.

Methods and systems are provided herein for assisting in the development of predictions by applying machine learning techniques to information drawn from disparate sources. The methods and systems may include taking data from a plurality of disparate sources, the sources available on a computer network; using the data to predict an outcome, the prediction based on an initial weighting of the sources; tracking the outcome; and feeding the sources and the tracked outcome into a machine learning facility, the machine learning facility adapted to adjust the weighting applied to the sources, thereby facilitating development of a modified weighting for the sources, the modified weighting being used to develop an inference as to the relationship between a source and the predicted outcome. In embodiments, the methods and systems may further include using the inference to generate a prediction based on additional data from a plurality of sources.

In some embodiments a machine learning system is used to assign weights, and optionally credits or rewards, to features or observations, such as extracted from disparate sources, in proportion to their relevance to making predictions.

The methods and systems disclosed herein address the challenges of making predictions in systems where there are many potential causes. By way of example, the stock price of a particular company may be affected by many different factors, such as the substance of its own press releases, press releases by other companies, interest rates set by the US and foreign governments, prices of input commodities, prices of goods and services at various points in a supply chain, consumer sentiment, consumer wealth, consumer tastes, availability of alternative goods and services, strategic initiatives proposed by the company or other companies, weather, geological factors, civil unrest, government regulation, decisions by courts or regulatory authorities, and many other factors. To develop a consistent, accurate and reliable econometric model to predict the stock price is very difficult. Rather than attempt to develop a closed model, the methods and systems disclosed herein take as inputs as many potential causal factors as possible, connecting thousands of data sources as inputs to a machine learning platform that makes predictions, compares predictions to actual results, and adjusts the weight that it gives to particular sources, strengthening the influence of data sources that lead to good predictions and weakening the influence of data sources that lead to poor predictions. Over time, the machine learning platform learns to make a prediction based on those input factors among the many it has considered that contribute most to accurate predictions. For certain kinds of predictions, especially those most dependent on small contributions from many different factors, the platform may generate predictions that are much more accurate than current models.

One embodiment of one aspect of the present invention utilizes machine learning in a system with three components, each component having three modes. The three components are a data collection facility (alternatively referred to herein in some cases as a “gatherer”), a prediction facility (or “predictor”), and an agent or other facility for taking action based on a prediction made by the prediction facility. In one embodiment, a gatherer, G, obtains observations, O, from a set of sources, S, and cleans and processes that information into a set of features, F. In some embodiments, these features, F, are time-series features with a value for each of a series of points in time. A predictor, P, takes a set of features, F, as input, and produces one or more predictions, W. In embodiments, predictions may be discrete predictions, or they may be represented as probability distributions over the value of a variable for each of a given set of points in time. For each of a set of times, t_1, . . . t_n, each W may specify a probability distribution for a variable x_i. An agent, A, may then take the predictions, features, and observations and specify one or more actions, a, in the world. In embodiments, the actions, a, results in various outcomes, and the agent receives a reward, R, based on the outcomes. The reward can be used as a feedback signal that can be utilized to drive the reinforcement of each of the components of the entire system; that is, machine learning, responsive to rewards assigned to particular outcomes, and be used to improve each element of the system, including components responsible for collection of sources, extraction of features and observations from sources, making predictions, or taking actions. Thus, each component can operate in an operational/execution mode or a learning mode. In embodiments, these modes may operate independently, but in other embodiments one or more components may operate simultaneously in operational/execution mode and learning mode. In certain embodiments the learner for the gatherer is responsible for searching over gatherers and choosing a complete instantiation of a gatherer to execute. The learner for the predictors may be responsible for improving the predictor—in general, for searching among the possible predictors and choosing a good one. The learner for the agent may be responsible for searching over possible agents and choosing a good one or taking an existing one and finding another agent near to it in agent-space that is an improvement on the original agent.

### BRIEF DESCRIPTION OF THE DRAWINGS

The invention and the following detailed description of certain embodiments thereof may be understood by reference to the following figures:

FIG. 1 depicts components of a platform for generating predictions based on abstractions and inferences drawn by applying machine learning techniques to predictions generated using a plurality of distinct information sources;

FIG. 2 depicts a range of applications capable of using a platform as described in connection with FIG. 1 by way of one or more interfaces;

FIG. 3 provides a flow diagram indicating steps for applying machine learning in a platform for generating predictions based on features and observations extracted from a plurality of data sources;

FIG. 4 depicts a matrix of features to which machine learning techniques may be applied to generate predictions;

FIG. 5 depicts a matrix of weightings applied to disparate features based on relative relationship of sources to the accuracy of predictions made based on the sources.

While the invention has been described in connection with certain preferred embodiments, other embodiments would be understood by one of ordinary skill in the art and are encompassed herein.

All documents referenced herein are hereby incorporated by reference.

### DETAILED DESCRIPTION OF THE PREFERRED EMBODIMENT(S)

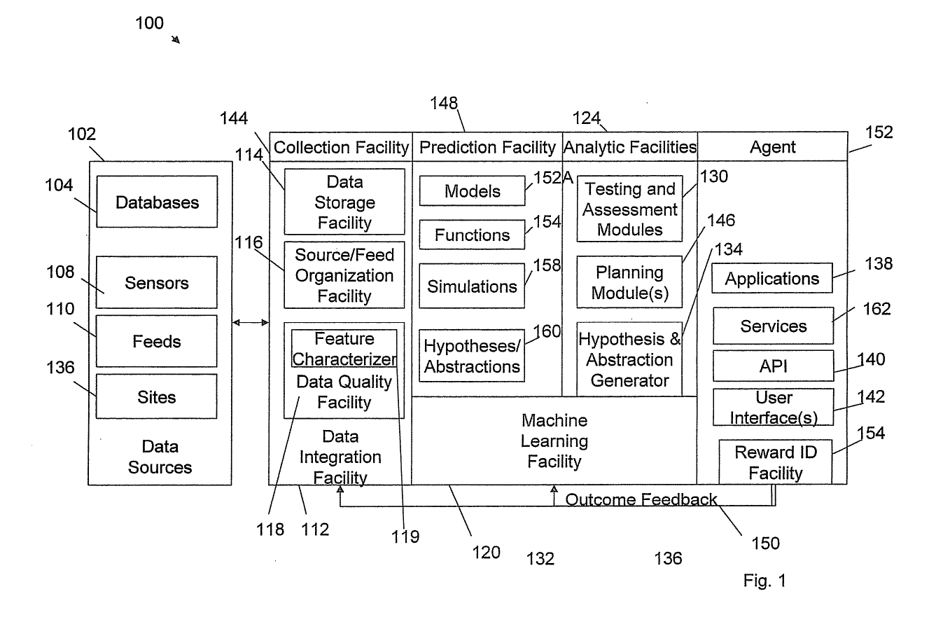

FIG. 1 depicts components of a platform 100 for generating predictions based on abstractions and inferences drawn by applying machine learning techniques to predictions generated using a plurality of distinct information sources. Various components may optionally be included in various preferred embodiments of the platform 100. A range of data sources 102 may be used as sources for the platform 100. Such sources may include data from databases 104 (which may be integrated databases, distributed databases, relational databases, object oriented databases, or other storage facilities), data feeds 110 (such as syndicated data feeds, streams of information published by news sites, or the like), data from sensors 108 (which should be understood to encompass sensors, detectors, transducers, and the like, including temperature sensors, cameras, optical sensors, heat sensors, pressure sensors, motion sensors, chemical sensors, and a wide range of others), data from one or more sites 136 (including data scraped or obtained by spiders, clustering facilities, or the like, such as data from web sites, network sites, or the like), and other data sources 102. Examples of data sources and types of data that can be used in preferred embodiments include data from e-commerce sites, data from auction sites, data from news, weather and sports information sites, data from stock exchanges, data from financial information sites, data from advertising networks, data from economic analysis sources, data from analysts, data from consulting organizations, data from standard organizations, geographical information, abstracted personal information from a large population of users of electronic devices, such as cell phones, data from governmental sources, agricultural information, information about commodities, information about securities, information about options and futures, information about housing and real estate markets, information about financial markets, medical information, epidemiological information, non-governmental organizational information, information about threats to security, information about warfare, data from stock markets (opening and closing numbers for indexes, funds and individual securities, and the like), data from commodities markets, weather data, data from bulletin boards (e.g., Craig's list, etc.), data from blogs about sentiment or emotion of individuals or groups, data about timing, market data (interest rate data, inflation data, employment data, price index data, census data, and the like) and many other types of information. It should be noted that any data source 102 of any type may be used as a data source 102 by the platform 100 (although it should be noted that, as described below, certain data sources 102 become preferred data sources 102 over time upon use of the platform 100).

Referring still to FIG. 1, a collection facility 144, also referred to herein as a gatherer, may be used to collect data from various sources. The collection facility 144 may include a data integration facility 112, which may include various features and components that may be used to integrate data from various sources. The collection facility 144 may include various collection processes, systems, methods and components, such as a facility for extracting data from a database (whether in a batch or continuous mode or both), a facility for extracting data via services, such as web services registered in a registry in a services oriented architecture, a facility for obtaining data via various “pulling” techniques, including querying one or more data facilities and collecting the results, a spidering facility, a scraping facility, a loading facility, or the like. The platform 100 may take collected data and store it in a storage facility 114 of the collection facility 144, which may be a database (distributed or integrated, a plurality of databases or storage facilities, object oriented or relational or the like), a data bag, a data mart, persistent memory or other suitable storage facility. The data integration facility 112 may extract, transform and load data of various source types into the data storage facility 114, such as using a bridge, a connector, a message broker, a queue, or other data integration facility, so that data is stored in a desired format in the data storage facility 114. The data integration facility 112 may include a data quality facility 118, which may cleanse data, deduplicate data from redundant sources, apply automated or human-aided rules for selecting among different data sources, verify the timeliness of data, verify the freshness of data sources, identify questionable data sources, and the like. The data quality facility 118 may, in embodiments, include a feature characterization facility 119 for characterization of the inputs to the platform 100. In embodiments, the feature characterization facility 119 may be used to identify one or more observations, O, in data sources and to process the observations into a set of features, F, such as a time series set of values for a range of points in time. For example, a data source presenting financial information about companies might have observations made about the stock of a company at a series of points in time. The feature characterization facility 119 may extract those observations (e.g., “recommended buy,” “recommended sell,” “recommended hold,” or the like) and characterize them as a time series value for that stock, possibly assigning one or more numerical values to represent the observations (e.g., 1 for buy, 0 for hold and −1 for sell). In embodiments, the feature characterization facility 119 may further be used to characterize information found in data sources, or the sources themselves, according to a wide range of attributes, such as by source, by domain, by origin, by authorship, by time of creation, by freshness, by authoritativeness, or the like. In embodiments, an operator of the platform 100 may be allowed to characterize certain inputs as, for example, preferred initial inputs to the platform 100, because such inputs are perceived to be likely reliable sources for certain kinds of predictions. The data integration facility 112 may also include an organization facility 116, described in more detail below, which may be used to organize data from data sources for suitable storage and analysis by the platform 100. In an embodiment, data sources are stored in a manner that permits ready access to data from disparate sources while maintaining clear identification of the source of a particular feature extracted from a source data. In embodiments the data quality facility 118 may also consider the availability of data, such as to identify ways in which the platform may continue to operate if a data source is unavailable. For example, the collection facility 144 may be prompted to find alternative sources for certain features if the standard source is unavailable, or the platform may use older data in cases where using it is not likely to have a significantly negative effect on the quality of the predictions generated by the platform.

The platform 100 may further include a prediction facility 148, or predictor, which may make one or more predictions based on features and observations collected in the collection facility 144. Predictions can take many forms, such as disclosed in connection with the various embodiments disclosed herein, ranging from those based on simple, direct relationships to predictions based on large numbers of features, predictions based on complex models, such as econometric models, weather models, computer simulation models, and the like. In general, a prediction can relate to any attribute of any future state of the world. In embodiments, a prediction may be made using a function 154, such as a function that can be captured using a fixed set of parameters, a function that uses a growing and data dependent set of parameters, a function that uses a non-parametric method (e.g., a program), or a hybrid of one of those. In embodiments, a prediction may be made using a complex function, such as embodied in a model 152A. In embodiments, a prediction may be made using a simulation 158, such as a computer simulation. In embodiments, a prediction may be made using a hypothesis or abstraction 160, which may lead directly to a prediction or may serve as a factor in a function, model, simulation, or the like.

In embodiments, the prediction facility 148 may include or be associated with a machine learning facility 120, which may, in a learning mode, use one or more machine learning techniques to improve predictions made by the prediction facility 148, such as by modifying predictions based on the outcomes of those predictions. The prediction facility 148 may operate in learning mode alone, in an operational/execution mode, or in simultaneous learning and operational/execution modes. The machine learning facility 120 may include a neural net, a partially specified program, or one or more of a wide range of other machine learning techniques. To facilitate learning, the prediction facility 148 may receive feedback 150, such as in the form of a reward, as to outcomes that result from various predictions. In embodiments, rewards may be fed back to the prediction facility 148 from an agent 152 of the platform 100 that takes actions based on the predictions of the prediction facility 148. In other embodiments, outcomes or rewards may be fed to the prediction facility 148 from other sources, such as computer models, simulations, external agents, sensors, or the like, in each case enabling the prediction facility 148 to improve the quality of its predictions in a learning mode.

In one embodiment, a machine learning facility 120 may use or comprise one or more partially specified programs for achieving an optimal or close-to-optimal action via the use of gathering and preparing data, making predictions on that data, and utilizing the predictions to choose a course of action. More specifically, a partially specified program (as described in Andre, David. (2003). Programmable reinforcement learning agents. Ph.D. dissertation, University of California, Berkeley, Calif. “(Andre 2003)”) is a computer program written with parts of the program left unspecified. A program-search can be utilized to create completions of the partial program. The method described in (Andre 2003) is one such method; another method would be genetic programming (as described in Koza, John. (1992) Genetic Programming: On the Programming of Computers by Means of Natural Selection. MIT Press. “(Koza 1992)”) yet another would be the Neural Programming method (as described Teller, Astro. (1998) Algorithm Evolution with Internal Reinforcement for Signal Understanding Thesis, Carnegie Mellon University, Pittsburgh, Pa. “(Teller 1998)”).

In certain embodiments, the platform 100 may include a variety of additional analytic facilities 124. Analytic facilities 124 may be used to analyze the platform 100 or components of the platform, including the collection facility 144, the machine learning facility 120 and the agent 152. Analytic facilities 124 may include testing and assessment modules 130 for assessment of, for example, the validity of predictions made by the prediction facility 148, such as using statistical techniques. Analytic facilities 124 may include a hypothesis and abstraction generator 134, which may generate one or more abstractions of hypotheses that can be used in the prediction facility 148, such as serving as initial conditions in the prediction facility 148 that will improve through machine learning facility 120. The hypothesis and abstraction generator 134, which may itself generate an inference or abstraction (or a set of them) based on a hypothesized relationship between, for example, features extracted from one or more data sources and one or more outcomes. Such abstractions themselves may be improved by machine learning 120 and may be tested for legitimacy by statistical techniques by the testing and assessment modules 130 of the analytic facilities 124. Such testing and assessment modules may consider various factors, such as consistency, accuracy, reliability, heteroskedasticity, auto-correlation, sample size, and the like in the abstractions or inferential equations proposed by the hypothesis and abstraction generator 134. The analytic facilities 124 may include one or more planning modules 146, which may provide input to the agent 152, either based on or associated with a prediction from the prediction facility 148. For example, the prediction facility 148 may predict that a stock will rise in price on a given date. The planning module 146 may allow an operator to plan to buy the stock in advance of the rise in price, based on the prediction from the prediction facility 148. It should be noted that analytic facilities 124 may comprise independent, standalone elements of the platform, but in embodiments one or more analytic facilities 124 may be embedded in one or more of the other components of the platform, including the collection facility 144, the prediction facility 148 or the agent 152. In addition, the platform 100 may be embedded in an independent analytic facility, such as provided by a third party, such as to feed analytic capabilities for a wide range of planning purposes.

In embodiments, the output of statistical analysis from the analytic facilities 124 may be fed via the feedback facility 150 to the machine learning facility 120, such as to support the aforementioned iterative feedback loop. The analytic facilities 124 may include a wide range of analytic tools, such as planning modules 146, business process rules, rules engines, tools for analyzing sales and marketing relationships, supply chain and inventory management tools, financial analysis tools, securities and commodities analysis tools, medical and epidemiological prediction tools, weather prediction tools, tools for predicting outcomes of events (including sporting events), and many others. Reports and other outputs from such tools may be provided as feedback to the feedback facility 150. In embodiments, the analytic facility 124 may include, either as part of the testing and assessment modules 130 or independently of them, a generalization assessment facility, by which an assessment can be made as to whether a type of prediction made by the platform 100 can be generalized (providing a useful model for predictions in future situations) or whether the prediction, even if accurate, is of a type that cannot be generalized, such as having been arrived at by chance, by over-fitting of results to a data set, or the like. Among other things, informed by the weightings determined in the machine learning facility 120, an operator of the generalization assessment facility may consider whether, for example sources to which high weights are athibuted are of a type that are likely to bear a logical, cause and effect relationship to the prediction in question. Such an assessment may be aided by a wide range of statistical techniques.

In embodiments the planning module 146 may include the hypothesis and abstraction generator 134 by which a user may supply a hypothetical input to the platform 100, such as to test the impact of that input on a prediction made by the platform 100. For example, a CEO considering a decision about the company may input that hypothesized decision to the platform 100 and obtain a prediction as to the impact of the decision on the company's stock price, where all other factors used in the machine learning facility 120 are taken from real data inputs. It should be noted that the hypothesis testing need not be limited to a single hypothesis; that is, one seeking a prediction could input many different scenarios involving many combinations or permutations of decisions, determining which combination or permutation is predicted to yield the best outcome. Thus, disclosed herein are methods and systems for making decisions, wherein a user supplies one or more hypothetical decisions to a machine learning facility 120 that otherwise takes inputs from a plurality of data sources in order to evaluate the impact of the hypothetical decisions based on predictions made by the machine learning facility 120.

The platform 100 may further include a machine learning facility 120, which may apply a wide range of machine learning techniques to each of the major components of the platform 100, including the collection facility 144, the prediction facility 148, and the agent 152. Various machine learning techniques 120 may be used, such as neural nets, artificial intelligence techniques, artificial neurons, self-organizing maps, support vector machines, genetic programming, and the like.

The platform 100 may further include the agent 152, which may take an action based on a prediction or group of predictions from the prediction facility 148, optionally guided by plans from the analytic facilities 124. For example an agent 152 may make a series of purchases and sales of a security, based on a time series of predictions from the prediction facility 148 as to the price of the security, executing a “buy low/sell high” strategy for the security. The agent 152 may be integrated as part of the platform 100 or may be part of a third party application, service, or the like. In various embodiments the agent 152 may use, or comprise, one or more applications 138, one or more services 162, or the like. In certain preferred embodiments an agent 152 may include one or more interfaces, such as user interfaces 142, application programming interfaces 140 or the like, allowing users, whether human or machine, to use the platform 100. It should be noted that while such interfaces are shown in FIG. 1 as part of the agent 152, other elements of the platform 100, such as the data collection facility 144, the prediction facility 148, and the machine learning facility 120 may have interfaces suitable for human or machine users, such as application programming interfaces, graphical user interfaces, or the like.

In certain preferred embodiments, the agent 152 may include a reward identification facility 154, which identifies the reward, credit, or the like that may serve as the outcome feedback 150 to the machine learning facility 120. The reward identification facility 154 may in turn determine a reward based on a large number of factors, including the direct outcome of a prediction (e.g., giving a reward for a correct prediction and a punishment for a wrong prediction), the indirect outcome of a prediction (e.g., the prediction was used in executing a profitable strategy), or the like. Rewards can be provided based on the performance of the agent 152 in real world situations, performance of the agent 152 in simulations, or a combination of the two.

The machine learning facility 120 may thus include a facility for handling the outcome feedback 150, such as the reward from the reward identification facility 154 of the agent 152. The machine learning facility 120 may use such rewards to apply machine learning to each of the components of the platform 100, including the data collection facility 144 (such as to identify the most valuable data sources, to identify the most valuable features and observations made by data sources, and to identify the most effective processes for extracting features from the data sources), the prediction facility 148 (such as to select the most effective predictive models, simulations, hypotheses, functions, or the like), the analytic facilities 124 (such as to generate better hypotheses or abstractions, to generate better models for planning, or the like) and the agent 152 (such as to improve selection of actions based on predictions).

In one embodiment, using machine learning techniques, features extracted from a plurality of data sources 102 may be supplied to the machine learning facility 120, along with an initial set of weights, such as representing a hypothesis about a relationship between the features and the predicted outcome. Subsequently, actual outcomes may be fed to the machine learning facility 120, which may iteratively adjust weights applied to the features from the data sources 102, seeking weightings that improve the extent to which predicted outcomes match actual outcomes. In this way, the machine learning facility 120 learns the value of features relatively emphasizing (by increasing weights) or de-emphasizing (by reducing weights) applicable to particular data sources. It should be noted that the machine learning facility 120 may be somewhat indifferent to the types of features or data sources 102 used or the initial weightings. For example, a feature of a data source 102 might provide a daily price for tea in China, with a weighting that predicts a direct correlation to the Dow Jones Industrial Index in the United States. Over time, an effective machine learning facility 120 will reduce the weighting for trivial items to zero while increasing weightings for relevant items to higher amounts. However, poor initial weightings or poor data sources may lead to the emergence of local optimization of weightings that are inferior to a more global optimization; therefore, in preferred embodiments more relevant features and more reasonable hypotheses about the relationship of a feature to an outcome are preferred. Thus, a well-understood micro-economic or macro-economic relationship, or even a rule of thumb widely accepted in industry, is likely to provide a better set of hypotheses and to suggest more relevant features and initial conditions for machine learning than an arbitrary set of data sources and weightings. In embodiments, as weightings converge the hypothesis and abstraction generator 134 may be used to draw weightings, relate them to highly weighted features, and provide an abstraction that may be used, for example, to provide an inference (or equation) used to make a prediction based on available features from the data sources 102.

As noted above, the platform 100 may include various interfaces by which human or machine users may access the predictions, analyses, weightings, abstractions, inferences, data sources, and the like that are generated or used by the platform 100. Such interfaces may include various graphical user interfaces 142, services 162 (such as web services or services registered and accessible via a services oriented architecture), and application programming interfaces 140 (for enabling computer access or access by application programs that may use various outputs from the platform 100. In embodiments, users may interact with a user interface to add, delete or modify data sources, select outcomes for prediction, make predictions, apply initial weightings to data sources, query data sources, modify weightings of data sources, access predictions, inferences or abstractions, generate reports, apply analytical tools, apply statistical analysis tools, apply planning tools, or the like. A user interface may include modules for enabling a workflow for generating a prediction based on a range of candidate data sources. In one embodiment, a user may drag and drop the information feature or data source 102 that a user wants to have included or excluded from the prediction facility 148. Similarly, a user may use a graphical user interface to adjust a machine learning facility 120, such as to adjust weights applied to particular features or data sources. Such an interface may resemble a graphic equalizer. By adjusting elements of the weighting, the user may view the effect on a prediction, such as to observe whether certain weights generate a good fit with real data. In some embodiments the user may also insert various components of their own as data sources, predictions, planners, strategies, or abstractions. These user-added components will be added in some embodiments in such a manner so as to provide initial starting assumptions for the machine learning process that can be further improved as described herein.

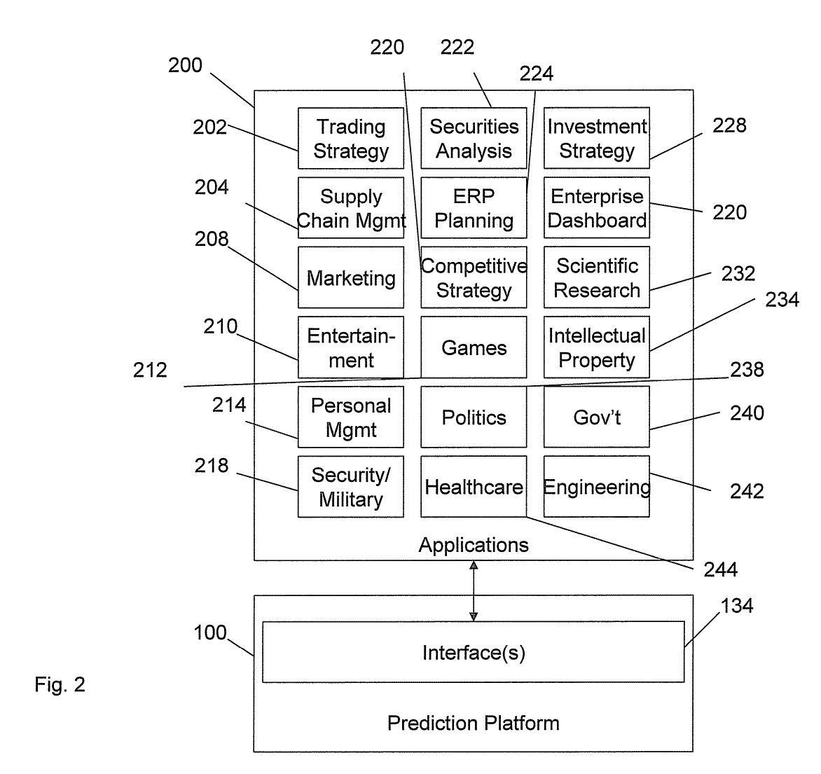

FIG. 2 depicts a range of applications 200 capable of using the platform 100 as described in connection with FIG. 1 by way of one or more interfaces, including user interfaces (such as integrated with a user interface of an application 200), services (such as web services and the like) and application programming interfaces. A wide range of applications may benefit from predictions generated by the platform 100, including trading strategy applications 202 (such as for investment bankers, traders, brokers, analysts, hedge fund managers, asset managers, individual investors, and the like to make predictions relevant to trading commodities, goods, services, securities, options, futures, or the like), supply chain management applications 204 (such as inventory management, manufacturing management shipping/transportation management, and the like), marketing applications 208 (such as applications for optimizing pricing, placement, promotion, positioning, and product mix, applications for targeting customer sets, applications for predicting consumer reaction to a product or service, applications relating to store openings and closings, applications for predicting consumer behavior, and the like), entertainment applications 210 (such as applications for predicting outcomes of events, applications for predicting consumer responses (such as to games, music, television programming, movies and the like)), personal management applications 214 (such as scheduling applications, personal information management applications, personal finance application, relationship and behavioral management applications, and the like), security or military applications 218 (such as for predicting behavior of entities in strategic games, predicting effects of political, diplomatic, or military strategies, policies or tactics, or the like), securities analysis applications 222 (such as for predicting prices of stocks, bonds, options, futures, derivative securities and a wide range of other securities and instruments), enterprise resource planning applications 224 (such as for planning sales, marketing, product, technology development, finance, real estate, research or other activities), competitive strategy applications 220 (such as selecting target markets, setting prices, and determining market strategies), gaming applications 212 (such as for predicting outcomes of components of games), political applications 238 (such as for predicting voter reactions to actions or events), healthcare applications 244 (such as for predicting outcomes of external events, courses of treatment, diagnoses, patient activities, health and wellness activities, environmental conditions, or other factors), investment strategy applications 228 (such as predicting effects of asset allocation strategies, hedging strategies, short and long strategies, predicting the effects of events and market conditions, and the like), dashboard applications 220 (such as presenting predictions in enterprise management dashboards), scientific and research applications 232 (such as predicting events or behaviors in psychology, preventing courses of disease in an individual or population, modeling behavior of complex systems, or the like), intellectual property applications 234 (such as predicting directions of innovation), government applications 240 (such as predicting important economic indicators such as inflation, unemployment, interest rates, and the like), and engineering applications 242 (such as predicting events relevant to determining relevant design parameters for a product or system, making predictions for failure mode effect analysis, or the like), among many others. In embodiments, the platform 100 may be used by consumers, such as for predicting airfares, prices of goods and services, outcomes of auctions, and the like.

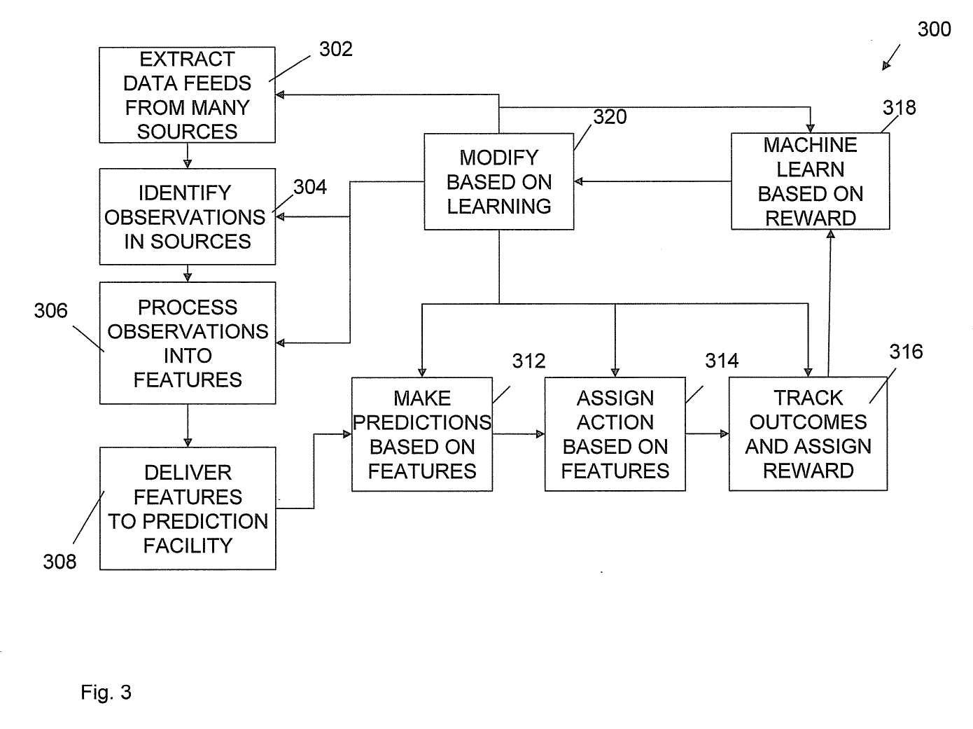

FIG. 3 provides a flow diagram 300 indicating steps for generating predictions based on application of machine learning to components of the platform 100, including the data collection facility 144, data sources 102, such as data feeds from a plurality of sources, the prediction facility 148, the analytic facilities 124 and the agent 152. At a step 302 data is extracted from sources 102, preferably a variety of disparate sources 102, such as data from feeds, data scraped from web sites, data extracted from databases, and the like. At a step 302 the data feeds may be organized by source 102, such as in a matrix that allows access to all sources 102 while distinctly identifying each source 102. At a step 304 one or more observations may be identified in the data sources 102, which in turn may be processed at a step 306 into one or more features. At a step 308 processed features may be delivered to the prediction facility 148. At a step 312 the prediction facility 148 may make one or more predictions. Optionally guided by the analytic facilities 124, at a step 314 the agent 152 may assign or undertake an action based on the prediction from the step 312. At a step 316 the platform 100 may track the outcome of the action, such as using the reward identification facility 154 and assign a reward, credit, or the like. At a step 318 the reward or the like may be delivered to the machine learning facility 120, which may apply machine learning, such as relevant to one or more of the components of the platform 100. At a step 320, based on the machine learning, the platform 100 may improve one of the other steps, such as the extraction of sources at the step 302, identification of observations at the step 304, processing of observations into features at the step 306, making predictions at the step 312, undertaking actions at the step 314, rewarding actions at the step 316, or even learning at the step 318. In one embodiment, at the machine learning step 318, a weighting may optionally be provided. The weighting at the step 318 may be made initially based, for example, on a hypothesis about the relevance of a feature extracted at the step 306 to a prediction made at the step 312. For example, if the prediction is the outcome of an outdoor sporting event, then a source related to weather may be provided with a moderately high weighting, while if the prediction were for the outcome of an indoor sporting event, the weighting for a weather source might initially be lower, based on the hypothesis that weather would have little or no impact on the indoor event. The weighting may be based on various rules, such as embodied in equations, algorithms, engines, or the like, that are capable of taking data, applying weights, and generating predictions. At the step 312, a prediction may be generated based in part on the weightings applied to various features from various sources and based on some function, model, rule, equation, algorithm, hypothesis, or the like. The prediction step 312 may be based on a large number of data sources, and itself may be either a simple prediction (such as of a binary state, such as “win/lose”, “on/off,” “up/down”, etc.) or a complex prediction (such as of a series of events, of a cardinal state (e.g., the level of a stock market index), the shape of a curve, or the like). At the step 316 outcomes may be tracked and compared to the predictions at the step 312. At the step 318 the machine learning facility 120 may assign weights to the various features, such as assigning higher weights to features that appear to have higher predictive relevance and lower weights to features that appear to have lower predictive relevance. In embodiments weights for features may be stored in a matrix, such that the matrix may be applied to the sources. In embodiments weighting of features may be normalized, such that the weights are appropriate in the context of the type of data (ordinal or cardinal, discrete or continuous, binary or not, etc.), the units used to measure the data, and the like. In embodiments at an optional step a user may modify an inference, hypothesis, rule or the like, such as based on the revised weightings suggested by the machine learning facility 120, based on other information, or the like. The weights determined at the step 318 and any modified inferences may be used as weightings in the modification step 320, which in turn may be used to generate additional predictions at the step 312, outcomes of which can be tracked at the step 316 and compared to the predictions from the step 312, for the purpose of further modifying the weights at the step 318. At any time a modification at the step 320 may be generated, based on the latest outcomes identified at the step 316 and the latest learning at the step 318. Over time in this embodiment, weightings emerge that provide strong influence to the most predictive features, while diminishing the relative influence of weakly predictive features. The machine learning facility 120 thus learns what features are valuable and favors them in preference to other features. By observing what features are found to be valuable, a user (whether a human user or an application of some kind), can develop rules, inferences, hypotheses, or the like based on the apparent relationship of a feature to the predicted outcome, and those rules (each of which can be embodied in an abstraction of hypothesis, such as fed via the analytic facilities 124 to the machine learning facility 120), can be tested against tracked outcomes at the step 316, such as to develop improved machine learning at the step 318 and to suggest modifications at the step 320.

It should be noted, that while initial weightings and hypotheses may be embodied in the flow 300, the system is relatively indifferent as to the number and type of data sources 102 initially used, the number of features extracted, or the like. Features or sources 102 that have relatively little predictive value (or little independent predictive value), will be weeded out by their low weighting in the machine learning facility 120, while sources having high predictive value will be emphasized, so that over time the weightings developed at the step 318 effectively eliminate poor sources and develop good sources.

In embodiments, good features or sources may be enhanced, such as by rewarding providers of good features or sources 102 for their relevancy to making good predictions (such as by monetary reward). Similarly, rewards to poorly predictive sources may be reduced or eliminated. Thus, via a reward system, an ecosystem of highly predictive data sources (such as human experts, analytic sources, sensors, and the like) can be developed that, with appropriate weighting, as developed and used in the machine learning facility 120, can be used to make inferences (or inference rules) and generate predictions.

In some embodiments, various sets of predictions may be combined and utilized to reinforce related predictions. For example, predictions about related events can be used to inform the other predictions. Another example is where predictions may be made at multiple time scales and then compared for consistency, which, when it happens, might increase the weightings associated with those predictions as well as modifying the original predictions based on the consistency of the set of predictions.

The introduction of rewards for features or sources 102 potentially introduces the incentive for gaming behavior on the part of sources, such as providing a multiplicity of feeds, generating random feeds, copying or “stealing” feeds from better sources, and the like. Thus, analysis of source behavior, such as statistical analysis by the analytic facilities 124, may be used in a fraud detection facility, which may be used to identify and deter or eliminate fraudulent or gaining behavior on the part of sources. Examples of methods of identifying this type of fraud or sources of dubious incremental information include: finding sources that are related to each other through a simple transformation such as an inverse or an increment by a fixed amount or a scaling of all values by a fixed factor, finding sources that are related to each other by similarity of when the information arrives, the IP addresses from which they arrive, or other header or identification information about the sources, finding sources that are duplicates or simple transformations of publicly available sources such as sources that pass through (with possible transformations) data sources such as the current price of oil or the current temperature on Boston, finding sources that are too regular such as a sawtooth pattern, a sine wave, or a square wave, and finding sources that are too strongly linearly correlated using simple linear models. It is also important to be able to detect when a source of data that has been valuable has turned malicious, meaning that whoever controls that data stream is now purposefully feeding data through the stream to the system that is designed to hurt the system's performance. Examples of detecting such malicious data include noticing that sources of data are now filled with a few examples of real data that are constantly repeated, noticing that sources of data are now random values or even values that have the wrong type (for example, having “cow” in a field that used to contain currency information), noticing that sources of data are repeating data from the past that has already been sent, noticing that sources of data that can be read in multiple ways (e.g. data scraped from a website that can be scraped from multiple IP addresses) do not match each other (thereby indicating that where the data is read from affects the data delivered), and noticing that data has very different information and entropy characteristics.

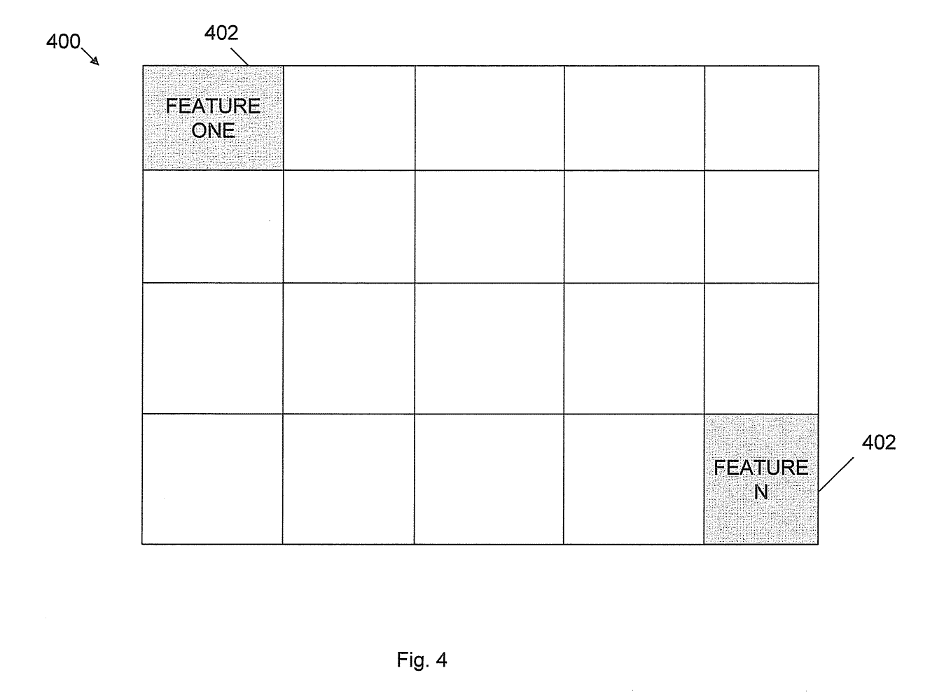

FIG. 4 depicts a matrix of data features from data sources 102 to which machine learning techniques may be applied to generate predictions. A first feature 402 can be represented in a cell of a matrix, with each feature 402 having a unique identifier and unique cell in the matrix, so that a plurality of separate data features 402 can be tracked for use by the machine learning facility 120.

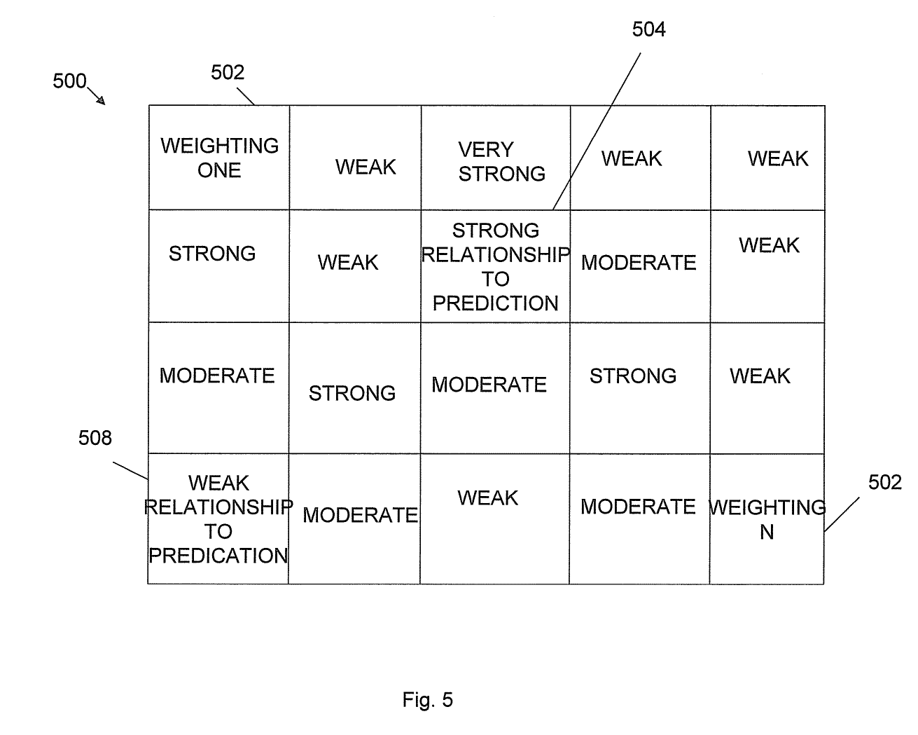

FIG. 5 depicts a matrix of weightings 500 applied to disparate features based on relative relationship of sources to the accuracy of predictions made based on the features. The weightings, represented in FIG. 5 as “weak,” “moderate,” “strong,” “very strong,” and the like, can be applied to features 402, based on the relative predictive power of a feature to prediction of a particular outcome. It should be noted that relative strength could be embodied in a number (such as a coefficient) or an equation, rather than as a qualitative state, so that a matrix effectively represents a “spreadsheet” for making predictive calculations based on source data. In embodiments, matrix elements 502 can be tied to each other, such as to enable complex calculations, algorithmic calculations, and the like, with inputs taken from disparate sources 102, and weightings developed by a machine learning facility 120, as depicted in connection with FIG. 3. The weightings may be normalized to reflect different data types, scales, and the like, as noted elsewhere herein. Certain preferred embodiments may be understood by reference to an example, related to the problem of choosing how to bet on a football game, such as a hypothetical game to occur between the Steelers and the Jets. One could bet directly on the outcome of the game (win or loss) and bet with odds; one could bet with even odds against the point spread; one can bet for which team will be leading at half-time; one can bet at a sports-betting facility; and one can bet using a trading market, such as an online trading market. In this example, the agent 152 may choose how much to wager and which bet or bets to place. To make these bets, the agent 152 may simulate many possible future states and compute the expected returns under each possible approach to wagering (such as via completion of the agent's partial program, following (Andre 2003)). To do the simulation, the system may use predictions produced by the prediction facility 148, or predictor. The predictor can produce probability distributions for the score by each team at the end of each quarter of the game, probability distributions over quarterback ratings, yards gained by each team, turnovers, and other metrics of the game. In one embodiment, these probability distributions are produced using a dynamic probabilistic network (Murphy, Kevin (2002) Dynamic Bayesian Networks: Representation, Inference and Learning Thesis, UC Berkeley, Computer Science Division) where the parameters are learned using past games as guides. These networks include both observed and hidden variables. The observed variables may constitute the observations and features produced by the data collection facility 144, or gatherer. The gatherer, in one embodiment, comprises programs that scrape information from websites (such as the quarter by quarter scores of past games, quarterback ratings, yards gained, sacks, turnovers, and other statistics of the game). In one embodiment these programs simulate a human browsing in a standard web browser and can click through even complex web pages to get access to the nuggets of information that can be useful as inputs for the predictor. In the present embodiment the list of such inputs includes the standard box scores, the details of the schedule (which team is the home team, for example), the injury report, predictions made by game-betting sites such as twominutewarning.com, current market prices on betting-markets such as TradeSports.com, and the expected weather in the home city of the game in question (e.g., from wunderground.com). These pieces of information may be cleaned and sanity checked in the data collection facility 144, then turned into features by the feature-creating part of the data collection facility 144. This is where the data collection facility 144 is only partially specified so that the system can learn which combinations of inputs (and methods for combining said inputs) are best with which to make predictions. In one embodiment this is performed using a stochastic beam search through program space (e.g., Genetic Programming) (Koza 1992). In another, reinforcement learning methods are utilized (Andre 2003).

An important component of a system that searches in program space is the notion of a fitness function. In order to choose a completion of a partial program, the system must have a means to evaluate each completion. One method for doing this is to use back testing, where the system is run using “old” input data and compared against actual outcomes. When doing this, avoiding over-fitting (where details of the past are learned instead of a generalizable model) is very important. An embodiment limits the search space to simple programs, does “look-forward” cross-validation where models are tested on past data, then retrained on that data, then retested on less old data, repeating until the models have been tested on the full set of past data.

Another aspect of the present embodiment is that the platform 100 uses machine learning to perform learning on each component in turn. First, observations are gathered, cleaned, and turned into candidate features by the data collection facility 144. These features serve as input to the prediction facility 148, which produces probability distributions. These distributions can be compared against the actual results for training. Additionally, the distributions can be utilized to drive a simulation of “then-future” games, which can then be utilized to train the agents 152. When doing training on each component, the other components, in one mode of the present embodiment, may be held constant. One additional aspect of another embodiment of the present invention is that of approximate reward functions. Instead of holding the prediction facility 148 and the agent 152 constant and evaluating each completion of the data collection facility 144 in turn, using the resulting reward (payoff) as the test of fitness, one can further optimize by learning an approximate valuation function based on features of the completion. This is a regression problem (for example, estimating the value V given features of the structure being searched over, in this case, completions of the partial program). This method is described in (Teller 1998) for the neural programming language and is related to the methods used by Boyan, Justin, Moore, Andrew. (2001) Learning evaluation functions to improve optimization by local search. The Journal of Machine Learning Research Volume 1. 77-112 in his dissertation. The notion is that an approximate reward function can be utilized to find only those completions where it is worth spending considerable time to evaluate them. This allows for a rational allocation of back-testing time (Teller, Astro, Andre, David (1997). Automatically Choosing the Number of Fitness Cases: The Rational Allocation of Trials. Genetic Programming 1997: Proceedings of the Second Annual Conference. 321-328).

Certain known systems, such as the website twominutewarning.com, have created probabilistic models from past data, using that data to run simulations of games to determine a winner. However, in the present disclosure input data sets are gathered in a paradigm where the input features can be learned. In addition, the agent 152 of the present platform 100 may test a wide range of strategies, whether or not relying on human decision making. Also, the present disclosure may, in certain embodiments, use partial programming as part of machine learning.

As noted above, the methods and systems disclosed herein can be used in a wide range of predictive applications.

The methods and systems disclosed herein can be used to make predictions in a wide range of environments, including financial, business, personal, and government environments, among many others.

In one embodiment, methods and systems disclosed herein may be used to make predictions for consumers. For example, a prediction of the future price or availability of an item of goods or services the consumer wishes to purchase may be made, taking as inputs data sources related to a host of factors that could affect the price, similar to the factors noted above that might affect stock prices. Predictions of prices, for example, can then be used to make plans, such as a plan to purchase a flat screen TV at the right time of day from the right retailer on the right day of the month, or to purchase tickets for an event at a predicted low point in price. A consumer could also set up a system by which the platform 100 would alert the customer as to when a prediction falls within a particular threshold, such as predicting that a price of a desired item falls within the consumer's budgeted range. Similar alerts can be used in other environments, such as by supply chain managers bulk purchasing components, materials or supplies related to a business at desired price levels. Timely predictions can allow individuals, managers, government officials, and the like to anticipate and prepare for changes, preferably avoiding adverse surprises.

In another embodiment a platform 100 may be used by businesses to predict factors that govern sales, marketing or supply chain decisions; for example, a business may predict a future price or level of demand from one of its customers (at various points in a value chain, ranging from end customers to retailers to resellers and distributors), or a business may predict a future price or level of availability of an item from one of its own suppliers or another party in the supply chain (such as manufacturers, distributors, resellers, OEMs, and the like). A prediction of a future price or level of demand or supply can be used to manage decisions and set plans, including demand plans, supply plans, inventory management plans, financing plans, shipping plans, and the like.

The methods and systems disclosed herein may be used to make market predictions, such as relating to the price of individual stocks, commodities, options, futures, derivatives, or the like; the prices of aggregations of the same, such as in mutual funds or as reflected by index levels; the levels of economic indicators and factors that influence markets, such as inflation rates, interest rates, price indices, levels of money supply, exchange rates, spending deficits, trade deficits, and the like; government actions, such as regulations, taxes, tariffs, embargos, restrictions on supply, subsidies, and the like; as well as many other factors. Market-related predictions can be used by individual investors, advisors, brokers, dealers, money managers, banks (including investment banks, central government banks), hedge fund managers, mutual fund managers, government officials, and many others in connection with making decisions and setting plans, such as plans for purchasing or selling securities, taking short or long positions, obtaining insurance, setting interest rates, setting taxes, any a host of others. In embodiments a decision maker can supply inputs to the model, such as an input that would result from making a particular decision. For example, the CEO of a company could supply an announcement to the platform 100 and see what the platform 100 predicts would occur to the company's stock price if the CEO were to make that announcement to the public. Thus, the methods and systems disclosed herein may be used in scenario planning, with important inputs being presented to the platform 100 in a hypothesis testing facility 146 that allows a decision maker to consider the impact of the decision maker's own decisions on the predictions rendered by the model. Such a hypothesis testing facility 146 may be used by, among many examples, a fund manager considering taking a large position in a security, a CEO making an important decision about a company, or a government regulator deciding whether to change interest rates, raise taxes, or the like.

It may be noted that in various preferred embodiments inputs to the machine learning platform 100 may constitute outputs from existing models already used to make predictions. Existing models may be used to seed the initial conditions of the machine learning facility 120, such as to optimize the speed with which it converges on a high quality prediction (but at the risk of finding a local, rather than global, optimum). Existing models may also be used as inputs side-by-side with other inputs, such as inputs related to raw data. The machine learning facility 120 may then apply weights to the outputs of the various models, over time converging in some cases on predictions that may rely heavily on the existing models while in other cases relying on a range of inputs not considered by the existing models. For example, predictions in closed systems (such prediction of motions of objects in a vacuum) should converge to the underlying physical model, while predictions in more complex or random systems might continue to rely on a very large number of disparate inputs.

In embodiments, the platform 100 can be used to set up an alert or automated exchange to prepare and buy certain flights, hotel rooms, or other travel or accommodations goods or services, when the price for the trips is predicted by the prediction facility 148 to be at a low point for a given span of time. In such embodiments possible features extracted in the data collection facility 144 may include the cost of fuel, changes in cost of fuel, market changes, revenue announcements, stock exchange events, seasonal features, sudden demand influx (e.g., to go to the Super Bowl in Florida, and the like that are hypothesized to influence price fluctuations). The airlines, hotel chains, restaurants and other travel and accommodations businesses have price setting mechanisms, but absent receiving advance notice from the airlines as to price changes, a prediction facility 148 may allow consumers or businesses to reduce costs of travel and accommodations. The platform 100 can predict trends in other prices, just as in predictions related to the financial market or in sports betting. It may be noted that travel and accommodations businesses may use the platform 100 to predict pricing trends by competitors, so that they can set their own prices in a way that is to their advantage. Thus, the platform 100 can be used to assist in predictions used to make decisions related to pricing, creation of marketing programs, offering special discounts, offering promotions, positioning products, and the like, based on predictions of behavior of other enterprises. Similarly, the platform 100 can make predictions as to actions of competitors, such as competitors in the marketplace or competitors in strategic games, such as games played by enterprises, governments, parties to games, parties to conflicts (in the case of war games), and the like. Thus, if the airlines had this type of prediction machine, they might be able to take this tool on as a corporate/competitive tool, and not just understand what is influencing their own pricing (as an analysis tool), but also better create a system that incorporates or understands the supply and demands issues (affecting other airlines, their effect on their market, as well as many other influencers) that are relevant to optimizing pricing or other factors for best profit opportunity. The platform 100, in both the hands of the consumer and the supplier may create a dynamic in which predictions feed on each other, in particular if automated through “bots” and where the models are constantly dynamic. This may result in arriving at more optimal equilibria for both consumers and suppliers, in both cases allowing the parties to predict and act upon their predictions in a rational way.

In other embodiments, the prediction facility 148 of the platform 100 may be used to predict demand for a product, such as to assist an enterprise in determining how much of a product to build, to stock, to order, to design, or the like.

In another embodiment, a prediction facility 148 could be used to predict travel, such as the number of people who are going to fly between two locations. These predictions could be used to plan airline schedules, travel and accommodations packages, and the like.

In another embodiment a consumer may access a prediction facility 148 to predict a price over a span of time, such as to allow the consumer to put in condition orders, such as a limit order on a pair of shoes. A consumer could plan buying patterns based on predicted price patterns.

In another embodiment, an enterprise or individual could use a prediction facility 148 in connection with an agent 152 configured to work with an auction site or product search engine. The agent 152 could, based on predictions, determine what items are getting closed out, what items are increasing or decreasing in popularity, what items are going for higher than suggested prices consistently, what items tend to have high reserve prices, and the like. Thus, an agent 152 could interact with an auction facility to buy or sell items, using predictions of pricing, supply or demand to assist execution of favorable strategies.

In another embodiment, a prediction facility 148 may provide predictions to an agent 152 configured to work with a search engine. Predictions as to trends in advertising prices, trends in search topics, or the like may be used to configure elements of marketing campaigns, such as bidding for keywords, allowing an enterprise to execute an effective marketing strategy based on such predictions.

In another embodiment, predictions from the prediction facility 148 may be used in connection with wealth management, whether through a hedge fund or through a personal saving account. Predictions as to market factors, such as prices, supply and demand, combined with predictions as to other factors, such as the appreciation of assets, may be used in combination to assist in wealth management.

In embodiments, the prediction facility 148 may be used to make predictions as to an entertainment factor, such as predicting what entertainment items are most likely to be highly entertaining to a particular consumer (which can be used to help target advertising to that consumer or to help the consumer find preferred content). Other predictions in the entertainment domain may include predictions as to what items are most likely to be most popular (by category of content, by individual title, or the like), what individuals are most likely to become stars, or the like. Predictions can also be used to guide creation of entertainment content, such as predicting what action someone will take in a particular situation and producing a surprising effect as a result.

In embodiments, an enterprise may use a prediction facility 148 for a wide range of activities, including predictions as to competitive products or companies, predictions as to pricing, predictions as to merger and acquisition activities, predictions as to effects of press releases, predictions as to product feature sets, price points, and points of sale/distribution, predictions as to impacts of actions on revenues, predictions as to the effect of actions on a company's stock price, and many others. For example, if one were the CEO of a company and could be presented with a prediction of where the company's stock price is going to be, and some indication of the sensitivity to various elements of the business (e.g., if you announced a patent, announced the CEO was fired, etc.), such predictions could be used to adjust actions to improve the performance of the stock.

In embodiments, predictions may relate to political factors, such as predicting voter preferences at a future point in time. Predictions could be made based on various hypotheses (as generated by the analytic facilities 124), such as predicting results if a candidate spends time talking about a particular subject, such as foreign policy, as compared to another subject. If the platform 100 looks at data from thousands of sites on the Internet and predicts what the polling numbers are going to be in three months, one can look at the sensitivity of the prediction to various inputs. If certain inputs produce high sensitivity, a politician could change factors related to those inputs. A user can find out sensitivities by putting random perturbations on real values into the inputs. The platform 100 can make a prediction, and the predictive model is sensitive to these inputs. Over time, as the system learns, the model will have looked at enough data such that it is not random. In this and other optional embodiments, each input may have a tag associated with it (e.g., sector tags, consumer discretionary spending, consumer required spending, energy, education, health care, domestic/international, official government sources/mediated sources/non-mediated sources). In such cases, a user could ask about sensitivity related to inputs with a certain tag. For example, a user could go through “housing” tags to see what the sensitivity is to talking about housing, rather than talking about another topic, such as national security. The prediction facility 148 would show sensitivity to those inputs, which in turn could be used to plan the dialogue.

Thus, in certain preferred embodiments the platform 100 can be used to generate predictions 148 the sensitivities of which can be used by analytic facilities 124 to provide guidance as to actions that could affect the predicted outcomes. Thus, platform 100 can enable a “cause and effect” dashboard that, by sorting out key features as having high predictive importance, offers users insight as to how to change the underlying causes that yield predictable outcomes.

It may be noted, that when the platform 100 makes predictions, the analytic facilities 124 may be used to figure out whether a prediction is likely to have sufficiently generalized based on its track record. If one predicts every day whether the stock market will go up or down, whether the weather will be sunny, or the like, one can examine how often the prediction is correct and figure out an approximation as to whether a given day's prediction is likely to be right or wrong. If the platform looks at thousands of potential input data sources 102, some of them are likely just to have been lucky in making predictions. The platform 100 may thus include analytic facilities 124, including testing and assessment modules 130, that seek to determine whether a particular data source 102 or feature is just getting lucky. For example, all other things being equal a small model (with a small number of degrees of freedom) is more likely to generalize, but it needs to have sensitivity to its data. If one changes the inputs, the model should be sensitive. A model that is insensitive to inputs can be identified as potentially weak. A testing and assessment module 130 may also compare a feature from an input 102 to another feature. This module 130 allows differentiation between mere chance (because something will correlate no matter what if you look at enough inputs) and real cause and effect (which is susceptible to prediction). Thus, in certain embodiments, the prediction facility 148 and the platform 100 may be used as a method of identifying causation, starting with a wide range of inputs and selecting those with the strongest causal relationship to an item to be predicted.

In another embodiment, a prediction facility 148 may be used in connection with a governmental activity, such as managing health care, such as predicting trends in diseases, predicting responses to disasters, predicting trends relevant to health insurance costs, predicting factors relevant to budgets (such as tax revenues), and the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, interne client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms, of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1-64. (canceled)

65. An automated system, comprising:
an automated collection facility for taking data from a plurality of disparate sources and characterizing a plurality of features within the data sources;
an automated processing facility in communication with the collection facility and programmed to provide
(i) an automated prediction facility for making a prediction based on the plurality of features;
(ii) an automated non-human agent for automatically taking an action based on a prediction of the prediction facility;
(iii) an automated reward identification facility for determining at least one of a reward and a punishment based on the outcome of the action taken by the automated agent, and
(iv) an automated machine learning facility for improving the selection of features within the collection facility; and
an automated feedback facility in communication with the processing facility for feeding the reward or punishment to the machine learning facility.

66. The automated system of claim 65, wherein the machine learning facility improves a method of prediction within the prediction facility.

67. The automated system of claim 65, wherein the machine learning facility improves the determination of an action within the agent.

68. The automated system of claim 65, further comprising providing an analytic facility for generating a hypothesis for use by the prediction facility.

69. The automated system of claim 65, further comprising an assessment module for assessing the validity of the hypothesis.

70. The automated system of claim 65, wherein the prediction is used to inform an application, wherein the application is selected from the group consisting of trading strategy, supply chain management applications, marketing applications, entertainment applications, personal management applications, security applications, military applications, securities analysis applications, enterprise resource planning applications, competitive strategy applications, gaming applications, political applications, health care applications, investment strategy applications, dashboard applications, scientific applications, research applications, intellectual property applications, government applications, and engineering applications.

71. The automated system of claim 65, further comprising an analytic facility for deriving an explanation for a cause and effect relationship based on the nature of the inputs that have a favorable influence on the prediction.

72. The automated system of claim 65, further comprising a generalization facility for assessing the extent to which a prediction based on an input can be generalized.

73. The automated system of claim 65, wherein the machine learning facility uses a partially specified program.

74. An automated system, comprising: an automated collection facility for taking data from a plurality of disparate sources and characterizing a plurality of features within the data sources;
an automated processing facility in communication with the collection facility and programmed to provide—
(i) an automated prediction facility for making a prediction based on the plurality of features,
(ii) an automated non-human agent for automatically taking an action based on a prediction of the prediction facility,
(iii) an automated reward identification facility for determining at least one of a reward and a punishment based on the outcome of the action taken by the automated agent, and
(iv) an automated machine learning facility for improving a method of prediction within the prediction facility; and
a feedback facility in communication with the processing facility for feeding the reward or punishment to a machine learning facility.

75. The automated system of claim 74, wherein the machine learning facility improves identification of features within the collection facility.

76. The automated system of claim 74, wherein the machine learning facility improves the determination of an action within the agent.

77. The automated system of claim 74, further comprising providing an analytic facility for generating a hypothesis for use by the prediction facility.

78. The automated system of claim 74, further comprising an assessment module for assessing the validity of the hypothesis.

79. The automated system of claim 74, wherein the prediction is used to inform an application, wherein the application is selected from the group consisting of trading strategy, supply chain management applications, marketing applications, entertainment applications, personal management applications, security applications, military applications, securities analysis applications, enterprise resource planning applications, competitive strategy applications, gaming applications, political applications, health care applications, investment strategy applications, dashboard applications, scientific applications, research applications, intellectual property applications, government applications, and engineering applications.

80. The automated system of claim 74, further comprising an analytic facility for deriving an explanation for a cause and effect relationship based on the nature of the inputs that have a favorable influence on the prediction.

81. The automated system of claim 74, further comprising a generalization facility for assessing the extent to which a prediction based on an input can be generalized.

82. The automated system of claim 74, wherein the machine learning facility uses a partially specified program.

83. An automated system, comprising:
an automated collection facility for taking data from a plurality of disparate sources and characterizing a plurality of features within the data sources;
an automated processing facility in communication with the collection facility and programmed to provide—
(i) an automated prediction facility for making a prediction based on the plurality of features,
(ii) an automated non-human agent for automatically taking an action based on a prediction of the prediction facility,
(iii) an automated reward identification facility for determining at least one of a reward and a punishment based on the outcome of the action taken by the automated agent, and
(iv) an automated machine learning facility for improving the determination of an action within the agent; and
an automated feedback facility for feeding the reward or punishment to a machine learning facility.

84. The automated system of claim 83, wherein the machine learning facility improves a method of prediction within the prediction facility.
